(19) United States
(12) Patent Application Publication
(10) Pub. No.: US 2012/0094821 A1
(43) Pub. Date: Apr. 19, 2012

(54) METHOD AND DEVICES FOR PRODUCING OPTICAL GLASS ELEMENTS, PARTICULARLY CONCENTRATOR OPTICS

(76) Inventors: Christian Schenk, Ingelheim (DE); Ulrich Fotheringham, Wiesbaden (DE)

(21) Appl. No.: 13/265,605

(22) PCT Filed: Apr. 22, 2010
(86) PCT No.: PCT/EP10/02462

§ 371 Date: Dec. 30, 2011

(30) Foreign Application Priority Data
Apr. 22, 2009 (DE) 10-2009-018-203.9

(51) Int. Cl. C03C 3/00; C03B 23/045; C03B 21/00; C03C 19/00

(52) U.S. Cl. 501/11; 65/61; 65/104; 65/105; 65/227; 65/176

(57) ABSTRACT

a method and to an apparatus for producing optical glass elements, in particular for producing what is referred to as low-cost optics for focusing light onto small areas, for example, for photovoltaic applications or optical couplers. The method for producing the optical glass elements includes: providing a glass rod having a selected cross-section, heating the glass rod such that it can be deformed in at least some sections, molding at least one optical glass element from the deformable section using a molding tool, separating the optical glass element from the glass rod at the connection, arranging a plurality of separated optical glass elements to form a group, and grinding and/or polishing at least one section of the separating surfaces of the grouped optical glass elements. The invention makes it possible to produce optical glass elements that meet low quality requirements in high quantities and with high output at low cost.

### DESCRIPTION OF THE INVENTION

The present invention relates to a method and to an apparatus for producing optical glass elements, in particular for producing what is referred to as low-cost optics for focusing light onto small areas, for example, for photovoltaic applications or optical couplers.

### BACKGROUND OF THE INVENTION

In the prior art, high-precision optical glass elements are obtained, for example, from a block made of optical glass by means of cutting, grinding and subsequent polishing. This, however, is a time-consuming and cost-intensive method. Moreover, additional problems arise in the production of miniaturized optical glass elements. First, the handling thereof is more difficult. Second, sufficient precision of the optically crucial properties is only possible with significant labor-intensive efforts, and consequently at significant cost. Edge definition, edge angle, flatness of the surfaces and low roughness of the surfaces decisively determine the quality of an optical glass element.

Another method for producing optical glass elements is precision press-molding, which is described in DE 10 2005 050 087 A1, for example. In precision press molding, a mold block is used. Such a mold block for precision press molding or precision molding optical components from glass generally comprises an upper mold and a lower mold. In the mold block, a viscous gob is hot-formed between the upper mold and lower mold. For this purpose, a heated parison made of glass and having a suitable viscosity is introduced into the optionally heated mold. The parison is heated to a suitable viscosity inside the mold block, is deformed by molding and cooled. An advantage of precision press-molded components is that the optically active surfaces no longer require finishing, so that subsequent operations such as grinding and polishing can be eliminated.

Although precision press molding can be used to produce high-precision optical glass elements, for example, having a surface quality of 1 μm (peak to valley), the method is not suited for mass production. In addition, not all applications require this kind of quality. For example, illuminating optics having considerably lower quality are still sufficient for headlights, such as concentrators.

### GENERAL DESCRIPTION OF THE INVENTION

Against this background, it is the object of the present invention to provide a method and an apparatus which at least mitigate the disadvantages of the prior art.

In particular, it should be possible to produce optical glass elements that meet low quality requirements in high quantities and with high output at low cost.

This object is already achieved by the method and the apparatus according to the independent claims. Advantageous embodiments are the subject matter of the respective dependent claims.

The invention first relates to a method for producing optical glass elements, comprising the following method steps:
providing a glass rod having a selected cross-section,
heating the glass rod so that it can be deformed in some sections or in at least some sections,
molding one or at least one optical glass element from the deformable section using a molding tool, in particular such that the molded optical glass element remains connected to the glass rod,
separating the optical glass element from the glass rod at the connection to the glass rod,
in particular arranging a plurality of separated optical glass elements to form a group,
in particular grinding and/or polishing the separating surfaces or at least one section of the separating surfaces of the grouped optical glass elements.

In addition, the scope of the present invention also includes a system for producing optical glass elements, comprising
a receiving device having receiving regions for glass rods made of optical glass,
a device for supplying the glass rods to the receiving regions,
a processing unit comprising at least
   one heating device for heating the glass rods in a first processing region so that the glass rods can be deformed in some sections or in at least some sections,
   one molding tool for molding one or at least one optical glass element from the deformable section in a second processing region,
   means for separating the optical glass element from the glass rod in a third processing region,
with the receiving device being movable relative to the processing unit so that the glass rods can be cyclically fed to the heating device, the molding tool and the separating means,
in particular a device for receiving a plurality of optical glass elements so that a group of optical glass elements can be assembled or is assembled and
in particular grinding and/or polishing means for grinding and/or polishing the separating surfaces or at least one section of the separating surfaces of the grouped optical glass elements.

The invention further relates to a system for producing optical glass elements, comprising
a device for supplying a glass rod made of optical glass to a processing region,
a heating device for heating the glass rod so that the glass rod can be deformed in some sections or in at least some sections in the processing region,
a processing unit comprising at least
   a molding tool for molding one or at least one optical glass element from the deformable section in the processing region and
   means for separating the at least one optical glass element from the glass rod in the processing region,
with the processing unit being movable relative to the glass rod so that the molding tool and the separating means can be guided cyclically into the processing region,
in particular a device for receiving a plurality of separated optical glass elements so that a group of optical glass elements is formed and
in particular grinding and/or polishing means for grinding and/or polishing the separating surfaces or at least one section of the separating surfaces of the grouped optical glass elements.

In a first embodiment, the heating device is part of the processing unit. In this variant, the heating device, the molding tool and the separating means could thus be guided cyclically into the processing region. In an alternative embodiment, the heating device is part of an apparatus for producing optical glass elements by means of a drawing process, comprising the aforementioned device for supplying, the heating apparatus and a drawing apparatus.

The systems are in particular designed to carry out the method according to the invention. The method can be carried out in particular by means of the systems according to the invention.

The glass rod can also be referred to as a glass bar. Its length is significantly greater than its diameter, but finite. Depending on the length of a glass rod that has been produced, first the length of the glass rod to be provided is adjusted. After the glass rod has been produced, the rod is preferably provided in the cooled state.

In a first variant of the invention, the glass rod is produced by a “primary shaping” operation. The glass rod is obtained by pouring a glass melt into a mold and subsequently cooling or solidifying it. In an alternative embodiment, the glass rod is produced by what is referred to as a “bar drawing method”. In this process, a glass strand is generally drawn off vertically or horizontally from a melt.

In order to ensure a particularly efficient production of the optical glass elements, the geometry and/or surface area of the cross-section of the glass rod that is provided are selected such that the rod is adapted to the cross-section of the optical glass element to be molded. Therefore, in one embodiment of the invention, the cross-section of the glass rod is thus first approximated or adapted to the cross-section of the optical glass element to be molded to the extent necessary prior to molding and/or heating. In one embodiment, for example, in order to obtain a smaller cross-section prior to molding, the cross-section of the glass rod is first tapered using a drawing method or “redrawing.” In a drawing method, the glass rod is supplied to a heating apparatus. The glass is heated until it can be plastically deformed. Using a drawing apparatus, the softened glass rod is drawn off the heating apparatus forming a bulb-shaped parison. The drawing process reduces the cross-section of the glass rod in a controlled manner.

In order to efficiently produce the optical glass elements, the separation process of the optical glass element from the glass rod should also take place in a time-reduced, and consequently cost-reduced, manner to the greatest extent possible. In a preferred embodiment of the invention, the optical glass elements are thus separated by means of “scoring and breaking” and/or “thermal breaking.”

In a next step, for example, the lateral faces of the optical glass element are polished in order to anneal the surfaces of the molded optical component. The polishing is carried out using at least one method selected from the group consisting of fire polishing, acid polishing and mechanical polishing. In order to again ensure particularly efficient production, the lateral faces of the optical element are preferably directly fire-polished by the molding tool. The lateral faces are also fire-polished during the molding process. Subsequent treatment of the lateral faces is then no longer required.

In contrast to the polished lateral faces, which generally no longer require finishing, finishing of the separating surfaces is still required, in particular due to the “scoring and breaking” and/or “thermal breaking.” According to the invention, the separating surfaces of the optical glass elements are thus jointly polished and/or ground. The optical glass element in general comprises both an upper separating surface and a lower separating surface. In order to make this processing step as efficient as possible, in a refinement of the invention, the upper separating surface and the lower separating surface of the grouped optical glass elements are polished and/or ground simultaneously or jointly.

The optical glass element is a glass element having any arbitrary suitable geometry. The optical glass element is, for example, a concentrator, an optical coupler, a polygonal prism, a lens, a rod lens and/or a glass element having convex, concave, spherical or aspherical, for example, elliptical, cylindrical or parabolic surfaces. The aforementioned glass elements shall be understood as being provided by way of example and are in no way restricted to the selection described. The invention also claims an optical glass element which can be produced or is produced by the method according to the invention.

The optical glass can be any arbitrary optical glass. The optical glass can be, for example, at least one of the following glasses: fluorine crown glasses, phosphorus crown glasses, phosphorus dense crown glasses, boron crown glasses, light barium crown glasses, crown glasses, zinc crown glasses, barium crown glasses, dense crown glasses, crown flint glasses, light barium flint glasses, extra-dense crown glasses, lanthanum crown glasses, extra-light flint glasses, barium flint glasses, light flint glasses, flint glasses, dense barium flint glasses, lanthanum flint glasses, dense lanthanum flint glasses, dense flint glasses, special crown glasses, special flint glasses, long-crown special glasses, special dense flint glasses, short flint glasses, short flint special glasses.

The present invention will be described in detail with reference to the following exemplary embodiments. Reference is made for this purpose to the accompanying drawings. The same reference characters in the individual drawings refer to the same elements.

### DESCRIPTION OF FIGURES

FIGS. 1 to 8 illustrate the individual steps of an exemplary embodiment of the method according to the invention.

FIG. 9 shows an optical glass element which can be produced, or is produced, by the method according to the invention.

FIGS. 10 to 12 each show a schematic view of an apparatus for carrying out the method according to the invention.

An aim of the present invention is to produce what is referred to as low-cost optics. Low-cost optics are optical glass elements 13, or optical components, which must be produced in large quantities with high output in a cost-effective manner and which are not subject to extremely high requirements in terms of their quality. For the end faces 13a or 13b, or lateral faces 13c, for example, flatness having precision of approximately 50 to approximately 250 μm (peak to valley), or even worse, is sufficient. The invention is particularly aimed at the production of optical components for focusing light onto small areas, for example, for photovoltaic applications and/or optical couplers.

The method according to the invention is based on “coupling” a hot finishing process with a cold finishing process. To this end, the optical components 13 are preferably produced in a completely continuous process within the scope of the hot finishing and cold finishing operations.

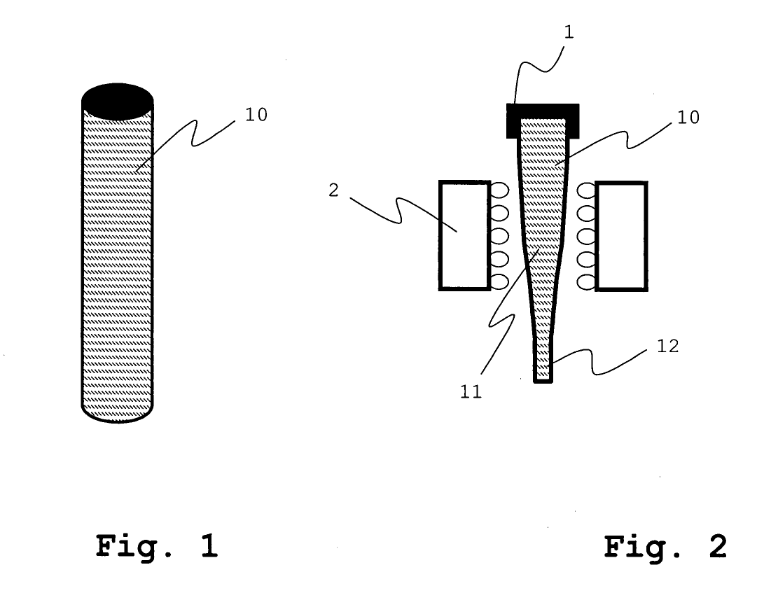

The production is carried out using rods or glass rods 10 as the starting product. The glass rods 10 are provided quasi “directly” from the melt. FIG. 1 illustrates the first step for producing the optical glass elements 13. The glass rod 10 is provided.

One option for producing the glass rods 10 is a hot shaping process, such as a “bar drawing method,” for example, in which a glass strand is drawn off vertically or horizontally from a melt. This variant is quite cost-effective because the glass rod 10 is provided using a continuous method.

As an alternative, the glass rod 10 can also be produced by a “primary shaping” operation. Here, the glass rod 10 is provided as raw glass, such as bar glass. A glass bar 10 or a glass rod 10 is produced from a glass melt by means of casting. This represents a discontinuous method. The raw glass can be cut into rods and optionally the cross-section thereof can be “rounded.”

The provided glass rod 10 preferably has a mean diameter in the range of approximately 20 mm to approximately 100 mm. In principle, any desired length may be selected. Depending on the design of the system, however, lengths of approximately 0.5 m to approximately 2 m should be employed. Any arbitrary optical glass can be selected as the glass. The glass rod 10 is preferably a solid material. However, a hollow material can also be used. In a preferred variant of the invention, the cross-section of the provided glass rod 10 has already been adapted to the cross-section of the optical glass element 13 to be formed. In the present example, the cross-section of the glass rod 10 is shown to be round or circular by way of example. However, it can also be polygonal, or polygonal in some sections, or round in some sections. Primary shaping is advantageous because preferably the cross-sectional surface area and/or the cross-sectional geometry can be deliberately predefined by appropriately selecting the casting mold.

To the extent necessary, the glass rods 10 that have been produced can undergo finishing at low cost. The cross-sectional geometry can be adapted by means of cold finishing, for example, sawing; however, this is relatively labor-intensive and consequently expensive. If, for example, a smaller cross-section is to be provided, preferably having a mean final diameter of less than 20 mm, drawing or “redrawing” of the glass rod 10 can optionally take place. Here, the provided glass rod 10 is supplied to a heating device 2 by means of a supplying device 1. The glass is heated such that it can be plastically deformed. The drawing device draws the deformable glass rod 10 off the heating device, forming a bulb-shaped parison, and the cross-section of the glass rod 10 is reduced in a controlled manner. Here, drawing is used exclusively for tapering the cross-section. This is illustrated in FIG. 2. For purposes of clarity, the drawing device is not shown in the figure.

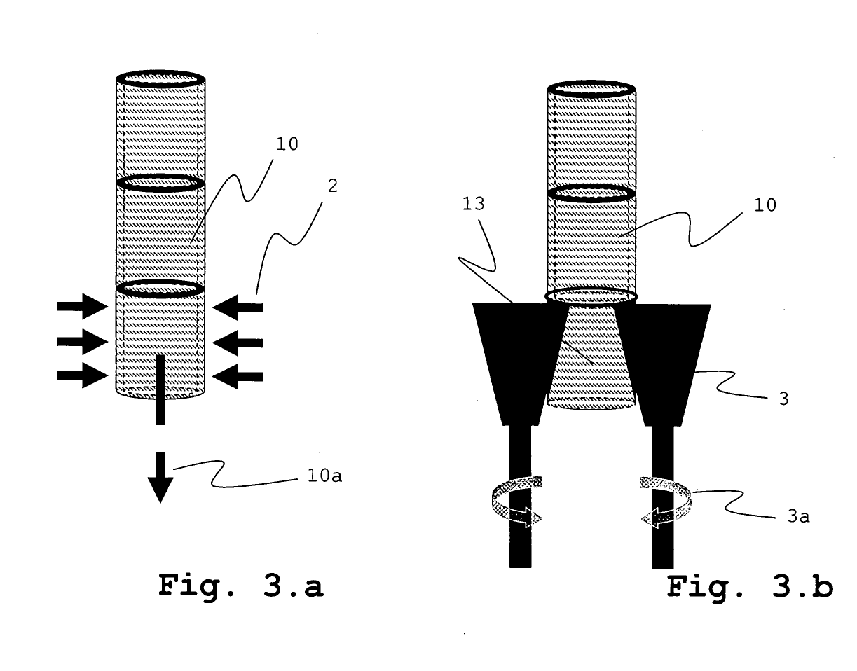

In a next or first processing step according to the invention, first the hot finishing operation is carried out. A first embodiment of the hot finishing operation is illustrated in FIGS. 3.a and 3.b. The glass rod 10 is heated in sections. In detail, at least the section is heated from which the optical glass element 13 is molded, in particular in a subsequent step. Heating can take place, for example, by means of gas burners 2 positioned around the glass rod 10. This is indicated by the arrows 2 (FIG. 3.a.). The glass rod 10 is heated so strongly in sections that at least the heated section, or at least a part of this section, can be deformed. For example, the optical glass element 13 is formed from the heated section of the glass rod 10 by plastic deformation. For this purpose, a molding tool 3 is used. The molding tool 3 is formed in the present example by two truncated cones as the negative mold. These cones are moved around the glass rod 10. Thus, first the heating takes place, and then the molding. The molding tool 3 is preferably also heated.

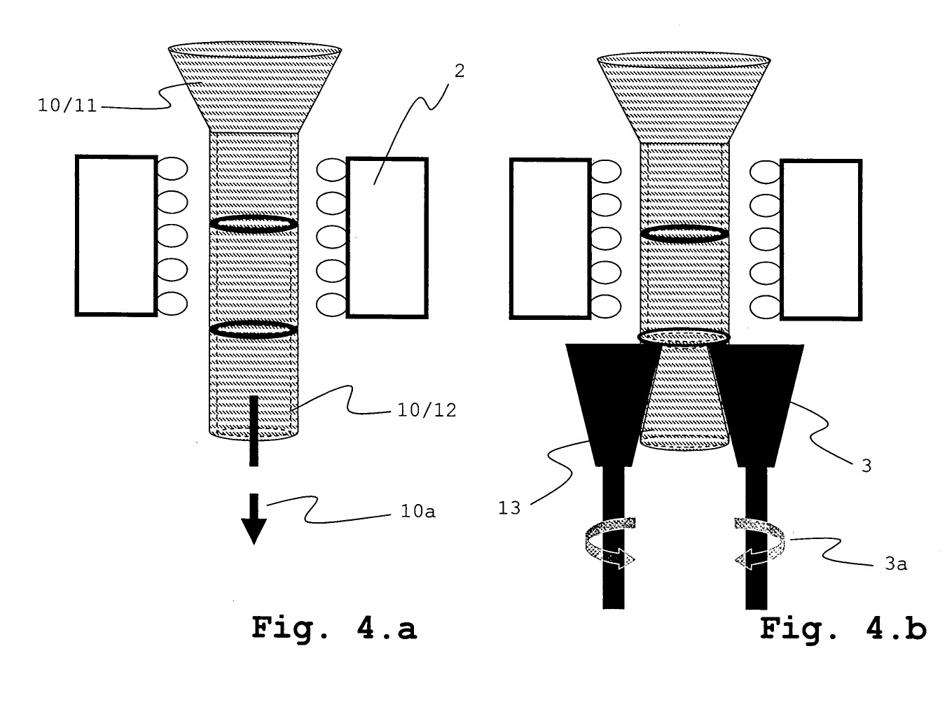

“Drawing” or “redrawing,” which is shown in FIGS. 4.a and 4.b, is an alternative hot finishing method. The provided glass rod 10 is fed to a heating device 2. The glass is heated until it can be plastically deformed. Using a drawing device (not shown), the deformable glass rod 10 is drawn off the heating device 2, forming a bulb-shaped parison 11, and the cross-section of the glass rod 10 is reduced in a controlled manner, with the optical glass elements 13 being molded from or on the tapered glass rod 12, which is to say the molding takes place at the tapered end of the bulb-shaped parison 11 or immediately after drawing. For details with respect to FIG. 4.b reference is made to the above description with respect to FIG. 3.b.

In one embodiment of the invention, the molding tool 3 is heated so strongly (in this respect, see FIGS. 3.b and 4.b) that the lateral faces 13c of the optical glass element 13, or the contact surfaces of the optical glass element 13 with the molding tool 3, are fire-polished. During fire polishing, the optical glass element 13, or the surface of the optical glass element 13, is heated so much that that the plastic-viscous glass surface is reduced under the surface tension and thereby becomes smooth. Prior heating may be omitted under certain circumstances, so that the heating and molding, or the heating, molding and fire-polishing, are carried out at the same time. In a further variant, the fire polishing can also be carried out after the molded glass rod 10 or the molded and separated glass element 13 has cooled.

The optical glass element 13 is molded or formed on the glass strand 10. In the present example, the optical glass element 13 remains connected to the glass strand 13 after molding, here by its end face 13a. The side or sides by which the connection to the neighboring glass element 13 or to the glass rod 10 existed is or are referred to as the end face 13a or 13b or end faces, or separating surface or separating surfaces.

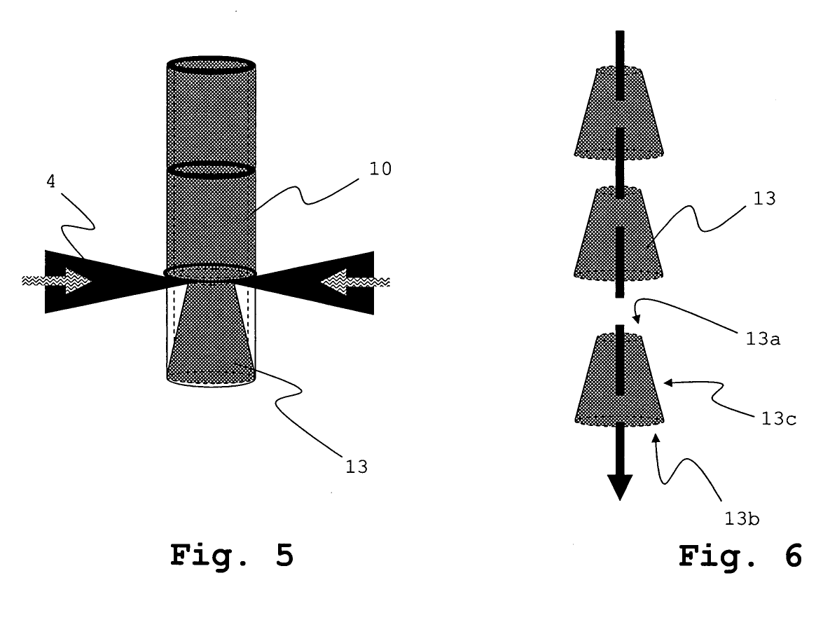

In a next step, the molded optical glass element 13 is separated from the glass rod 10, or the optical glass elements 13 are detached. This is illustrated in FIG. 5. For cost reasons, a “plastic” separating method is preferably employed. Examples of this include “scoring and breaking” or “thermal breaking.” In “scoring and breaking,” a predetermined breaking point is generated by scoring. The figure, in contrast, implies “thermal breaking”. The connection between the optical glass element 13 and the glass rod 10, which is still hot, is cooled locally by a cooling device 4, for example, by means of air or an air jet. The local cooling generates a defined and locally delimited stress profile in the glass. Starting from an incipient crack, the glass is separated in one operation by guiding the crack with the air jet. The cooling device 4 can be designed a pipes through which air flows, for example, in the form of cooling fingers. The separation here is still part of the hot finishing operation. A time- and cost-intensive separating method, such as sawing, can thus be avoided.

The detached optical glass elements 13 are illustrated in FIG. 6 as preliminary products. The aforementioned separating method, however, results in low-quality end faces 13a and 13b, thus necessitating finishing of the end faces 13a and 13b of the separated optical glass elements 13. For this reason, grinding and/or polishing are carried out in a subsequent step as part of the cold finishing operation. In detail, the end faces 13a and 13b, which are preferably planar and which after hot finishing are “arbitrarily” detached and therefore unmolded, are ground and/or polished.

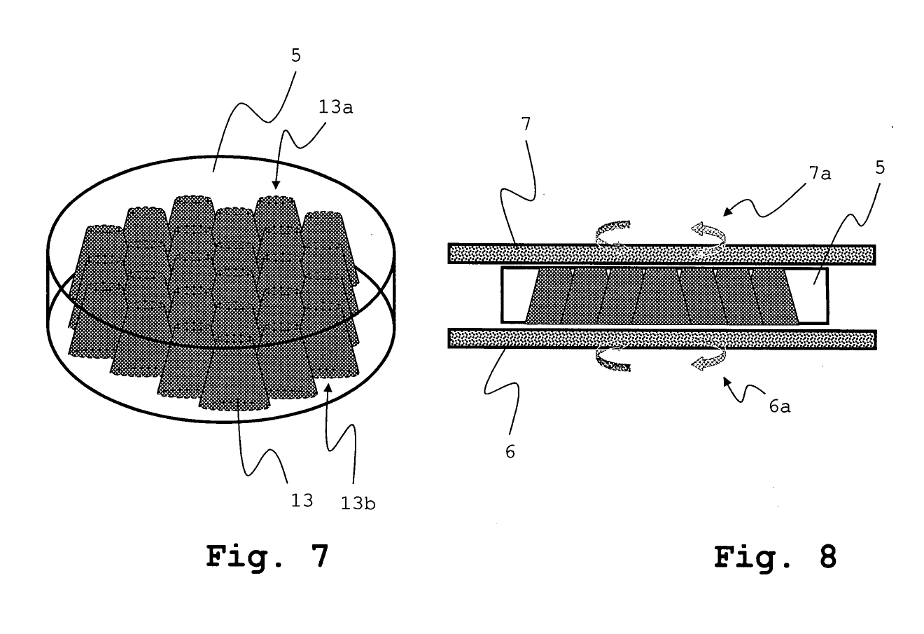

The subsequent cold finishing operation is shown in FIGS. 7 and 8. In order to achieve particularly cost-effective production, a plurality of optical glass elements 13 is ground and/or polished jointly. For this purpose, a plurality of optical glass elements 13 is positioned or grouped in a receiving device 5 to form an array. This is illustrated in FIG. 7. In order to obtain a stable combination during grinding and/or polishing, the optical glass elements 13 are optionally glued or cemented to one another, in particular in a separable fashion.

In the embodiment shown in FIG. 8, the upper end face 13a and the lower end face 13b are polished and/or ground simultaneously. In the present example, the grinding and/or polishing are affected by mechanical means. As an example, a grinding wheel and polishing wheel 6 and 7 are indicated. Polishing can also take place by means of acid polishing and/or fire polishing. In order to achieve particularly cost-effective production, however, the longitudinal sides 13c are preferably not finished. The fire-polished surfaces of the longitudinal sides 13c are preserved.

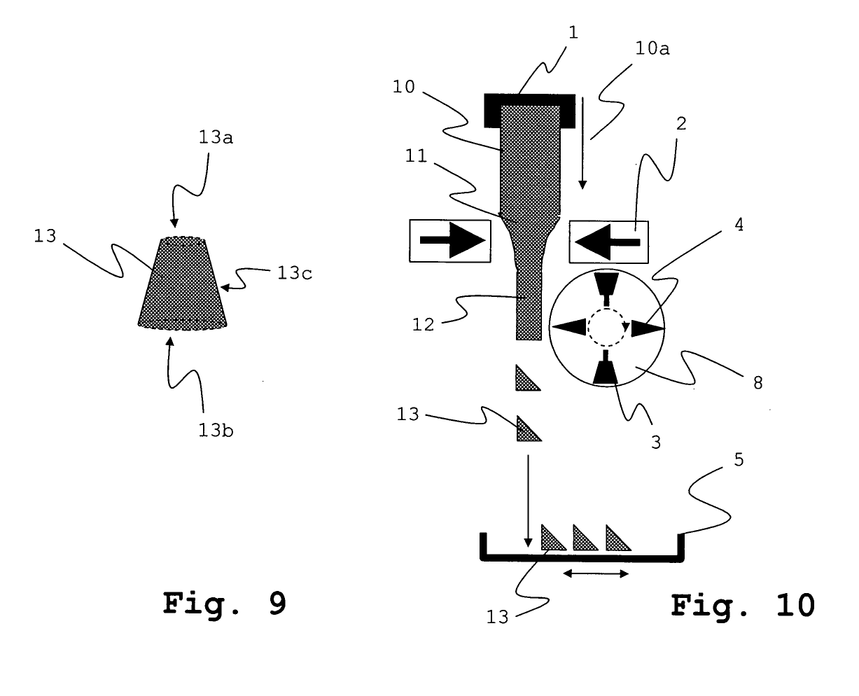

The end product is an optical glass element 13 that is produced in a cost-effective manner. FIG. 9 illustrates a potential embodiment of an optical glass element 13 produced according to the invention in the form of an optical concentrator, which is also referred to as concentrator optics. For the purpose of simplified illustration, the concentrator shown here has the shape of a truncated cone. The concentrator can also have the shape of a paraboloid, in particular in some sections. Another possible design of an optical glass element 13 is an optical coupler; however, this is not shown in the figures.

In principle, there is no restriction to the use of certain cross-sections. However, in order to enable particularly easy processing, the following geometrical requirements would be advantageous: conical or cylindrical, in particular with additional, preferably peripheral, contours. The optical glass element 13 should be essentially rotationally symmetrical and/or elongated. The length of the optical glass element 13 ranges between approximately 0.2 cm and approximately 10 cm.

While FIGS. 1 to 8 described above essentially illustrate the underlying principle of the invention, FIGS. 10 to 12 each show a system or apparatus for carrying out the method according to the invention. The symbols selected in FIGS. 10 to 12 are based on the symbols used in the figures above. In a first embodiment of the invention, the individual apparatuses or stations for carrying out the method, in particular the method steps shown in FIGS. 3 to 6, are mounted on a carousel 8 or a rotation device 8. In contrast, in one variant the glass rods 10 are disposed on a carousel 8 and the stations are disposed around the carousel 8. In both variants, the glass rods 10 and the stations are moved relative to one another. This ensures the cost-effective production of the optical glass elements 13.

FIG. 10 shows a side view of an exemplary system and relates essentially to the “alternative” hot finishing method illustrated in FIGS. 4.a and 4.b. A device for drawing off the glass rod 10 is not shown in the figure. The provided glass rod 10 is fed to a heating apparatus 2, for example, a heating muffle, and the processing region by the supplying device 1. The glass is heated by the heating apparatus 2 such that it can be plastically deformed and processed by a processing unit in the processing region. The processing region is defined by the region in which the glass rod 10 is processed. In the present example, the processing region includes the heating device 2 and the region below connected thereto, in which the optical glass element 13 is molded and severed. Here, the processing unit is formed by two molding tools 3 and two separating means 4. The separating means 4, or the separating device 4, is designed as a cooling device.

The processing unit is disposed on a carousel 8. The direction of rotation is indicated by an arrow in the center of the carousel 8. The molding tool 3 and the separating means 4 are guided or rotated into or to the processing region. The optical glass elements 13 are molded at the tapered end of the “bulb-shaped billet” 11 that is formed, or immediately after drawing. By supplying the softened glass rod 10 to the processing region and cyclically rotating the carousel 8 in an adapted manner, the optical glass element 13 is first molded from the softened end of the glass rod 10. In a next step, the molded optical glass element 13 is severed.

In the example shown, the finished optical glass elements 13 drop into a receiving device 5 after severing. This device can be laterally displaced so that a group of optical glass elements 13 can be formed. The lateral movement is indicated by the double arrow. The group that has been formed can then be finished together, for example, polished and/or ground. The severed optical glass elements 13 can likewise be positioned in the receiving device 5 by a gripper, which is not shown in the figures.

The selected vertical orientation of the carousel 8 and the selected number of two molding tools 3 and two separating means 4 on the carousel 8 have been selected for the purpose of a simplified illustration. A horizontal arrangement and/or a plurality of molding tools 3 and/or separating means 4 are also possible.

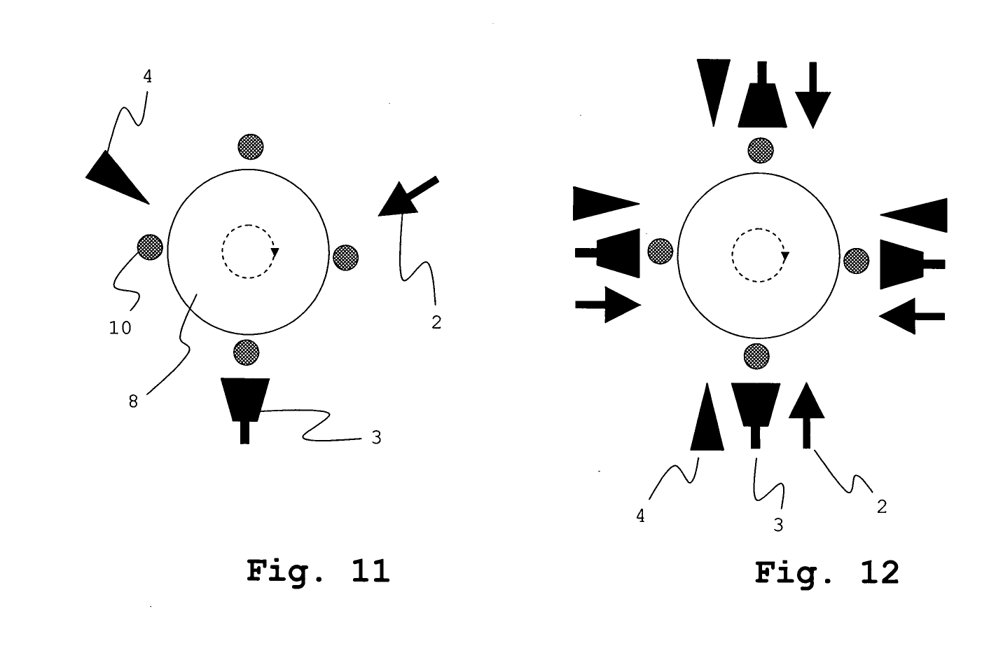

FIGS. 11 and 12 show an embodiment in which the glass rods 10 are moved. The processing units are now stationary. The systems shown there can also be referred to as “rotary devices.”

FIG. 11 shows a top view of a system or a “rotary device.” The system comprises a carousel 8, which is also referred to as a receiving unit and comprises a plurality of receiving regions for a plurality of glass rods 10. A device for supplying the glass rods 10, which is not shown in the figure, is disposed above the carousel 8, for example. The individual glass rods 10 drop into the individual stations or receiving regions. These stations or receiving regions are distributed over the circumference of the carousel 8 in the present example. The carousel 8 is cyclically advanced one station at a time in order to load the different stations. Over the course of a 360° rotation, the individual steps of the method are carried out. The direction of rotation is indicated by the arrow in the center of the carousel 8.

In the present example, the processing unit is formed by the heating device 2, the molding tool 3 and the separating means 4, preferably designed as a cooling device. The processing unit is, or the aforementioned components are, distributed over the circumference of the carousel 8. They are disposed in a stationary manner. A first processing region is formed in the region of the heating device 2, a second processing region is formed in the region of the molding tool 3 and a third processing region is formed in the region of the separating means 4. By means of a rotary motion of the carousel 8, the glass rods 10 are consecutively guided to the heating device 2, to the molding tool 3 and to the separating means 4 or to the respective processing region, or they are cyclically guided.

In the first processing region, the glass is heated by the heating apparatus 2 such that it can be plastically deformed. Thereupon, the deformable glass rod 10 is supplied to the molding tool 3. The optical glass element 13 is formed in the second processing region. Then, the optical glass element 13 that has been formed is supplied to the cooling device 4. It is severed in the third processing region. After separating, the finished optical glass elements 13 drop, for example, downward into a device for receiving the glass elements 13, which is not illustrated in the figure.

After the separating process, in a next step, the now-shortened glass rod 10 can be moved downward or into the plane of the processing operation so that, in a subsequent cycle or step, the “new” or exposed end of the glass rod 10 can be processed. The processing cycle starts from the beginning.

FIG. 12 essentially corresponds to FIG. 11. Here, in contrast to FIG. 11, multiple processing units, four in the example shown, are disposed around the carousel 8. In a single revolution, several processing steps can thus be carried out and a plurality of optical glass elements 13 can be produced.

It is obvious to a person skilled in the art that the embodiments described above are to be understood as exemplary. The invention is not limited to these and can be varied in diverse ways without departing from the spirit of the invention. Features of individual embodiments and each of the features mentioned in the general portion of the description can be combined among each other and with one another.

### LIST OF REFERENCE CHARACTERS

1 Supplying device

2 Heating device

3 Molding tool or means for molding

3a Direction of movement of the molding tool

4 Separating means or cooling device

5 Device for receiving the optical glass elements

6 Polishing and/or grinding means

6a Direction of movement of the polishing and/or grinding means

7 Polishing and/or grinding means

7a Direction of movement of the polishing and/or grinding means

8 Carousel or rotation device or receiving device comprising receiving regions

10 Glass rod or glass bar

10a Direction of movement or direction of drawing of the glass rod

11 Bulb-shaped parison

12 Tapered glass rod

13 Optical glass element

13a Upper end face or separating surface of the optical glass element

13b Lower end face or separating surface of the optical glass element

13c Lateral face or longitudinal side of the optical glass element

1. A method for producing optical glass elements, comprising the following method steps:
providing a glass rod having a selected cross-section,
heating the glass rod such that it can be deformed in at least some sections,
molding at least one optical glass element from the deformable section using a molding tool,
separating the optical glass element from the glass rod at the connection, arranging a plurality of separated optical glass elements to form a group,
grinding and/or polishing at least one section of the separating surfaces of the grouped optical glass elements.

2. The method claim 1, wherein the glass rod is produced by means of a primary shaping process.

3. The method of claim 1, wherein the glass rod is produced by means of a bar drawing method.

4. The method of claim 1, wherein the cross-section of the glass rod is approximated to the cross-section of the optical glass element to be molded.

5. The method of claim 1, wherein the cross-section of the glass rod is tapered by means of a drawing method.

6. The method of claim 1, wherein at least some sections of the lateral faces of the optical glass element are polished.

7. The method of claim 1, wherein the lateral faces of the optical glass element are fire-polished, preferably by means of the molding tool.

8. The method of claim 1, wherein the optical glass elements are separated from the glass rod by scoring and breaking and/or thermal breaking.

9. The method of claim 1, wherein an upper separating surface and a lower separating surface of the grouped optical glass elements are polished and/or ground simultaneously.

10. An optical glass element that can be produced or is produced by a method according to claim 1.

11. A system for producing optical glass elements, comprising:
a receiving device having receiving regions for glass rods made of optical glass,
a device for supplying the glass rods to the receiving regions,
a processing unit comprising:
one heating device for heating the glass rods in a first processing region such that the glass rods can be deformed in at least some sections,
one molding tool for molding at least one optical glass element from the deformable section in a second processing region,
means for separating the optical glass element from the glass rod in a third processing region,
with the receiving device being movable relative to the processing unit so that the glass rods can be cyclically fed to the heating device, the molding tool and the separating means,
a device for receiving a plurality of optical glass elements so that a group of optical glass elements can be assembled, and
grinding and/or polishing means for grinding and/or polishing at least one section of the separating surfaces of the grouped optical glass elements.

12. A system for producing optical glass elements, comprising:
a device for supplying a glass rod made of optical glass to a processing region,
a heating device for heating the glass rod such that the glass rod can be deformed in at least some sections in the processing region,
a processing unit comprising at least
one molding tool for molding at least one optical glass element from the deformable section in the processing region and
means for separating the optical glass element from the glass rod in the processing region,
with the processing unit being movable relative to the glass rod so that the molding tool and the separating means can be guided cyclically into the processing region,
a device for receiving a plurality of separated optical glass elements so that a group of optical glass elements is formed and
grinding and/or polishing means for grinding and/or polishing at least one section of the separating surfaces of the grouped optical glass elements.
